(19) United States
(12) Patent Application Publication
(10) Pub. No.: US 2013/0077367 A1
(43) Pub. Date: Mar. 28, 2013

(54) SYSTEMS AND METHODS FOR USE IN GRID FAULT EVENT CONTROL

(71) Applicants: Huibin Zhu, Westford, MA (US); David Smith, Daleville, VA (US); Anthony William Galbraith, Wirtz, VA (US); Maozhong Gong, Shanghai (CN); Xueqin Wu, Shanghai (CN)

(72) Inventors: Huibin Zhu, Westford, MA (US); David Smith, Daleville, VA (US); Anthony William Galbraith, Wirtz, VA (US); Maozhong Gong, Shanghai (CN); Xueqin Wu, Shanghai (CN)

(21) Appl. No.: 13/243,294

(22) Filed: Sep. 23, 2011

(51) Int. Cl. H02M 7/537; G05F 1/70

(52) U.S. Cl. 363/97; 323/205; 363/131

(57) ABSTRACT

System, power modules, and methods for supplying an output voltage to an electric grid are provided. One example power module includes a switching device configured to supply an output from a power generator to an electric grid, a feedback unit configured to provide a feedback signal indicative of a deviation of a parameter associated with the electric grid, and a controller coupled to the feedback unit and the switching device. The controller is configured to adjust a reactive current of the output in response to at least one grid fault event to ride through the at least one grid fault event, to modify the deviation provided from the feedback unit, to control the switching device based on the modified deviation, and to detect an islanding condition based on the parameter associated with the electric grid.

### BACKGROUND OF THE INVENTION

The subject matter disclosed herein relates generally systems and methods for use in supplying an output voltage to an electric grid.

Electric grids are known for distribution of electric power. A utility power generator is generally known to provide a substantial amount of power to the electric grid, while independent sources are connected to the electric grid to provide a local grid power and reduced dependence on the utility power generator.

Each of the independent sources is connected to the electric grid through a power conditioner and/or a converter to provide consistent and efficient coupling of the independent source to the electric grid. Under certain conditions, the electric grid may experience one or more grid fault events, such as low voltage, high voltage, zero voltage, phase jumping, etc. Often, electric grid operators require that independent sources connected to the electric grid be sufficiently robust to ride-thru grid fault events. Conversely, under some conditions, the utility power generator may be disconnected from the electric grid, leaving independent sources connected to the loading, which is referred to as islanding. In order to maintain the electric grid operators' control of the electric grid and/or prevent potential damage to the electric grid and/or loads or generators connected thereto, the electric grid operators generally require anti-islanding functionality. Anti-islanding functionality causes the independent sources to be disconnected from the electric grid, when the utility power generator is disconnected from the electric grid.

### BRIEF DESCRIPTION OF THE INVENTION

In one aspect, a power module for use in supplying an output voltage to an electric grid is provided. The power module includes a switching device configured to supply an output from a power generator to an electric grid, a feedback unit configured to provide a feedback signal indicative of a deviation of a parameter associated with the electric grid, and a controller coupled to the feedback unit and the switching device. The controller is configured to adjust a reactive current of the output in response to at least one grid fault event to ride through the at least one grid fault event, to modify the deviation provided from the feedback unit, to control the switching device based on the modified deviation, and to detect an islanding condition based on the parameter associated with the electric grid.

In another aspect, a power system is provided. The power system includes a power generator configured to generate a DC output and a power module coupled to the power generator and configured to convert the DC output to an AC output and provide the AC output to an electric grid. The power module includes a switching device and a controller coupled to the switching device and having a feedback loop. The controller is configured to control the switching device based on the feedback loop. The controller is configured to adjust a reactive current of the AC output in response to at least one grid fault event to ride through the at least one grid fault event. The controller is configured to inject noise into the feedback loop to detect an islanding condition.

In yet another aspect, a method for interfacing a power generator to an electric grid through a power module is provided. The power module includes a switching device and a controller coupled to the switching device. The method includes adjusting a reactive current of the output from the power generator in response to at least one grid fault event to ride through the at least one grid fault event, monitoring a deviation of a parameter from a nominal value, the parameter associated with the electric grid, and detecting an islanding condition when the parameter exceeds a threshold range for a predetermined interval.

### BRIEF DESCRIPTION OF THE DRAWINGS

FIG. 1 is a block diagram of an exemplary power system.

FIG. 2 is a block diagram of an exemplary power module that may be used in the power system of FIG. 1.

FIG. 3 is a block diagram of another exemplary power module that may be used in the power system of FIG. 1.

FIG. 4 is a block diagram of an exemplary method for use in supplying an output voltage to an electric grid.

### DETAILED DESCRIPTION OF THE INVENTION

The embodiments described herein relate to power systems and methods for use in supplying an output voltage from a power source to an electric grid. More particularly, the embodiments described herein relate to adjusting a reactive power of the output voltage from a power generator in response to a grid fault event, while providing anti-islanding functionality.

According to one or more embodiments, technical effects of the methods, systems, and modules described herein include at least one of: (a) adjusting a reactive current of the output from the power generator in response to at least one grid fault event to ride through the at least one grid fault event, (b) monitoring a deviation of a parameter from a nominal value, the parameter associated with the electric grid, (c) detecting an islanding condition when the parameter exceeds a threshold range for a predetermined interval, (d) modifying the deviation of the parameter, and (e) controlling the switching device based on the modified deviation.

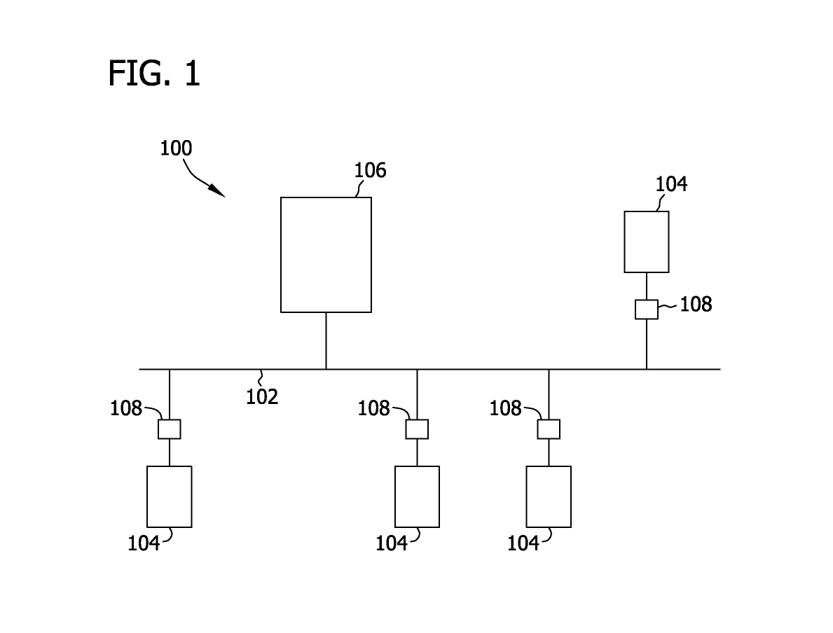

FIG. 1 illustrates an exemplary power system 100. In the exemplary embodiment, power system 100 includes an electric grid 102, multiple power generators 104 coupled to electric grid 102, and a major power generator 106 coupled to electric grid 102. Major power generator 106 is configured to provide a relatively major portion of power to electric grid 102, as compared to each of the power generators 104. In various embodiments, each power generator 104 may include, without limitation, one or more photovoltaic (PV) cells, wind turbines, hydroelectric generators, fuel generators, and/or other power generator devices, etc. Further, major power generator 106 may include, for example, a nuclear, coal, or natural gas power generator. It should be appreciated that power system 100 may include a different number and/or configuration of generators in other embodiments.

As shown, power system 100 includes a power module 108 coupled between each of power generators 104 and electric grid 102. In the exemplary embodiment, power module 108 is configured to safely and efficiently supply an output voltage from power generator 104 to electric grid 102.

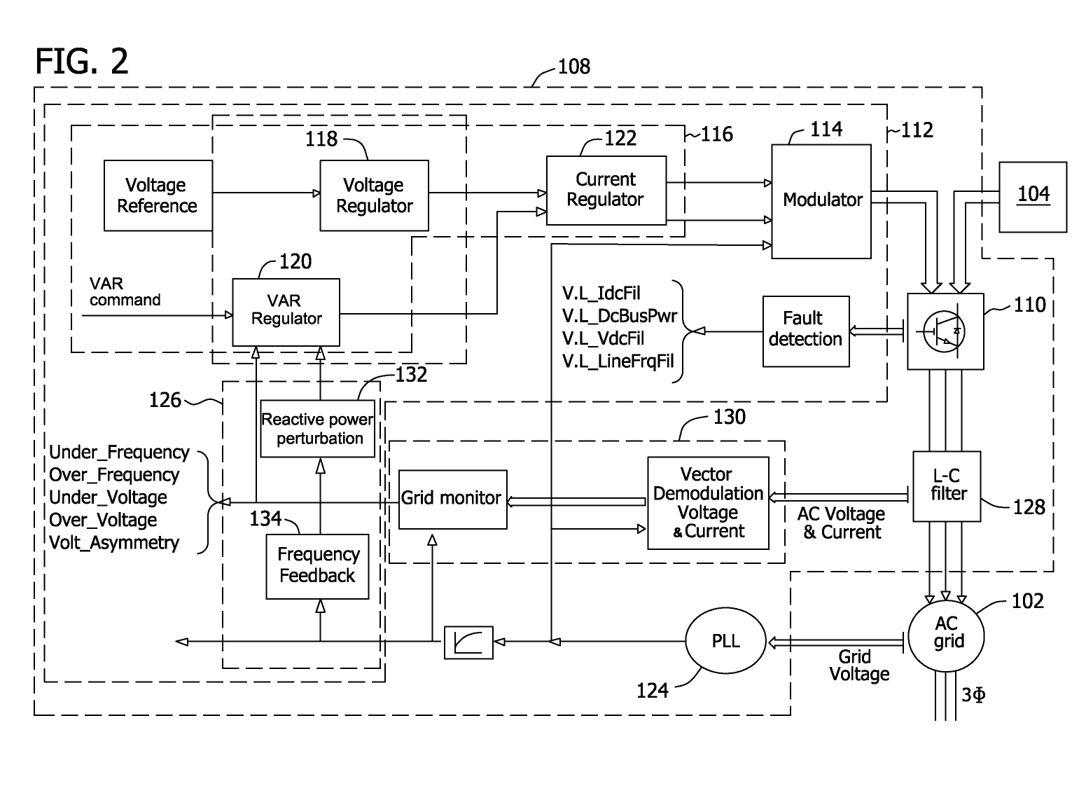

FIG. 2 illustrates an exemplary power module 108 for use in supplying the output voltage from power generator 104 to electric grid 102, while performing consistent with one or more processes and/or methods described herein. Power module 108 includes a switching device 110 coupled between power generator 104 and electric grid 102. While illustrated as a single switching device 110, it should be appreciated that switching device 110 may include one or more switching devices to provide single-phase or multiple-phase output voltage to electric grid 102. Further, while switching device 110 is illustrated as an insulated gate bipolar junction transistor (IGBT), it should be appreciated that one or more other switching devices or combination thereof may be used. For example, switching device 110 may include one or more field effect transistors (FET), silicon controlled rectifiers (SCR), bipolar junction transistors (BJT), thyristors or other devices suitable to provide an output power to electric grid 102.

In the exemplary embodiment, switching device 110 is an inverter circuit including multiple switching devices 110. The switching devices 110 are configured to switch ON and OFF according to one or more control signals to convert a DC voltage from power generator 104 to an AC voltage substantially consistent with the AC voltage of electric grid 102. As shown, the inverter circuit provides three-phase AC voltage to electric grid 102. In other embodiments, switching device 110 may include one or more switching devices configured to convert any form of power generated by power generator 104 (e.g., AC voltage) to a voltage substantially consistent with the voltage of electric grid 102.

In the exemplary embodiment, power module 108 includes a controller 112 coupled to switching device 110. Controller 112 includes a modulator 114 and a Volt-VAR regulator 116. Modulator 114 responds to commands from Volt-VAR regulator 116 to control switching device 110. More specifically, modulator 114 is configured to provide a PWM (pulse-width-modulated) signal to switching device 110 based on signals from Volt-VAR regulator 116. Modulator 114 outputs the PWM signal with a frequency, angle, and/or duty cycle to provide suitable active and reactive power to electric grid 102. In the exemplary embodiment, Volt-VAR regulator 116 includes a voltage regulator 118 and a VAR (volt-amp reactive) regulator 120. Voltage regulator 118 controls the active power supplied from power generator 104 to electric grid 102, while VAR regulator 120 controls the reactive power supplied from power generator 104 to electric grid 102. As shown, in the exemplary embodiment, Volt-VAR regulator 116 includes a current regulator 122 coupled between each of voltage regulator 118 and VAR regulator and modulator 114 to provide current regulation.

As shown in FIG. 2, power module 108 includes a feedback unit 124 coupled between controller 112 and electric grid 102. In the exemplary embodiment, feedback unit 124 is configured to detect various parameters associated with electric grid 102. As shown, feedback unit 124 includes a phase-lock-loop (PLL) circuit. In another embodiment, feedback unit 124 may include a zero-cross phase detector. The zero-cross phase detector is utilized, for example, to inhibit cross coupling between Volt-VAR regulator 116 and one or more modification circuits described herein.

Controller 112 includes a modification circuit 126 coupled to feedback unit 124. Modification circuit 126 includes a reactive power perturbation segment 132 and a frequency feedback segment 134 coupled between feedback unit 124 and reactive power perturbation segment 132. Reactive power perturbation segment 132 is coupled to VAR regulator 120. Power module 108 further includes a grid monitor 130 coupled to VAR regulator 120. As shown, grid monitor 130 is provided to detect under frequency, over frequency, under voltage, over voltage, voltage asymmetry, and/or other conditions associated with electric grid 102. In at least one embodiment, feedback unit 124 and grid monitor 130 may be incorporated together.

In the exemplary embodiment, power module 108 includes a filter circuit 128 coupled between switching device 110 and electric grid 102. Filter circuit 128 is provided to adjust (e.g., smooth, condition, etc.) an output voltage provided from switching device 110 to electric grid 102. In the exemplary embodiment, filter circuit includes an L-C (inductor-capacitor) filter. In other embodiments, one or more different filter circuits may be used to adjust the output voltage from switching device 110. In the exemplary embodiment, grid monitor 130 is coupled to L-C filter 128 to detect voltages and/or currents from switching device 110 and associated with electric grid 102. In other embodiments, grid monitor 130 is coupled otherwise to detect voltages and/or currents associated with electric grid 102.

In the exemplary embodiment, controller 112 is implemented in one or more processing devices, such as a microcontroller, a microprocessor, a programmable gate array, a reduced instruction set circuit (RISC), an application specific integrated circuit (ASIC), etc. Accordingly, in this exemplary embodiment, modulator 114, Volt-VAR regulator 116, and modification circuit 126 are constructed of software and/or firmware embedded in one or more processing device. In this manner, controller 112 is programmable, such that instructions, intervals, thresholds, and/or ranges, etc. may be programmed for a particular power generator 104 and/or operator of power generator 104. As shown, each of feedback unit 124 and grid monitor 130 are separate from controller 112, and thus separate from the processing device. In other embodiments, feedback unit 124 and/or grid monitor 130 may be integrated and/or programmed into one or more processing devices utilized to provide controller 112. Likewise, one or more of modulator 114, Volt-VAR regulator 116, and modification circuit 126 may be wholly or partially provide by discrete components, external to one or more processing devices.

During operation, feedback unit 124 provides a feedback signal indicative of a deviation of a parameter associated with the electric grid feedback to grid monitor 130 and modification circuit 126. In turn, frequency feedback segment 134 detects the deviation of the parameter associated with electric grid 102 and provides the deviation to reactive power perturbation segment 132. For example, frequency feedback segment 134 detects the magnitude and/or frequency deviation of a voltage associated with electric grid 102, such as the voltage at electric grid 102 or the voltage provided from switching devices 110. The deviation is detected based on a nominal value of the voltage associated with electric grid 102. For example, a nominal frequency value may be 60 Hz, and a nominal voltage value may be 120 VAC. In the exemplary embodiment, reactive power perturbation segment 132 modifies the deviation to adjust the amount of reactive current delivered from power generator 104. In particular, reactive power perturbation segment 132 amplifies the frequency deviation of the voltage associated with electric grid 102.

In this manner, the modification circuit 126 injects noise into the feedback loop, including controller 112 and feedback unit 124. In response, Volt-VAR regulator 116 controls modulator 114, based on the modified deviation to overcorrect the frequency deviation detected by feedback unit 124. More generally, Volt-VAR regulator 116 provides an output voltage with a frequency that intentionally deviates from the nominal frequency of the voltage associated electric grid 102. For example, the modified deviation may cause switching device 110 to provide an output voltage with a frequency of 61 Hz, when the nominal frequency of the voltage associated with electric grid 102 is 60 Hz. Accordingly, by modifying the deviation, which controls VAR regulator 120, power modules 108 is able to provide a directly proportional effect (e.g., 1:1) on the frequency of an output voltage supplied from power generator 104.

The injected noise has insubstantial affect on the frequency of the voltage associated electric grid 102 when major power generator 106 is coupled to electric grid 102. Specifically, the major power generator performs as a frequency regulator to hold the frequency of the voltage associated with electric grid 102 at its nominal value. The deviation from power module 108 is insufficient to drive the frequency away from its nominal value. Accordingly, during normal operation of electric grid 102, the modifications provided from modification circuit 126 has an insubstantial effect or no effect on the voltage of the electric grid 102.

Conversely, when major power generator 106 is disconnected from electric grid 102 (e.g., disconnected or non-operational), the noise injected by modification circuit 126 is detected by feedback unit 124. More generally, because major power generator 106 is disconnected and fails to regulate the frequency of the voltage associated with electric grid 102, power module 108 is permitted to drive the frequency of the voltage associated with electric grid 102 away from its nominal value.

In response to the modified deviation, frequency feedback 134 again detects the deviation, which is generally increased from the prior deviation. In turn, reactive power perturbation segment 132 further modifies the detected deviation. Accordingly, modification of the deviation repeats in a positive feedback manner, during the absence of the major power generator 106, to drive the frequency of the voltage associated electric grid 102 further and further way from its nominal value. As long as major power generator 106 is disconnected, the modification of the deviation continues until, eventually, the frequency deviation exceeds a threshold range. In one example, a threshold range for a frequency deviation is about ±3 Hz of its nominal value. In other embodiments, the threshold range may be about ±2 Hz, about ±5 Hz, or another suitable threshold range for power generator 104 and/or electric grid 102. In still other embodiments, where magnitude of a parameter (e.g., a voltage or current) associated with electric grid 102 is modified, a threshold range may be about ±10%, about ±20%, about ±30% or another suitable percentage of its nominal value. It should be appreciated that a variety of different threshold ranges may be used in other power module embodiments.

Controller 112 monitors the frequency deviation of the voltage in excess of the threshold range relative to a predetermined interval, such as, for example, about 200 milliseconds, about 500 milliseconds, about 1 second, about 2 seconds, etc. When the frequency deviation exceeds the threshold range for the predetermined interval, controller 112 detects the islanding condition and responds accordingly. In one example, power module 108 may respond to the islanding condition by disconnecting power generator 104 prior to damage to electric grid 102 and/or power generator 104. In other examples, controller 112 may shutdown power module 108 and/or may perform one or more other suitable operations to inhibit damage and/or issues potentially resulting from the islanding condition.

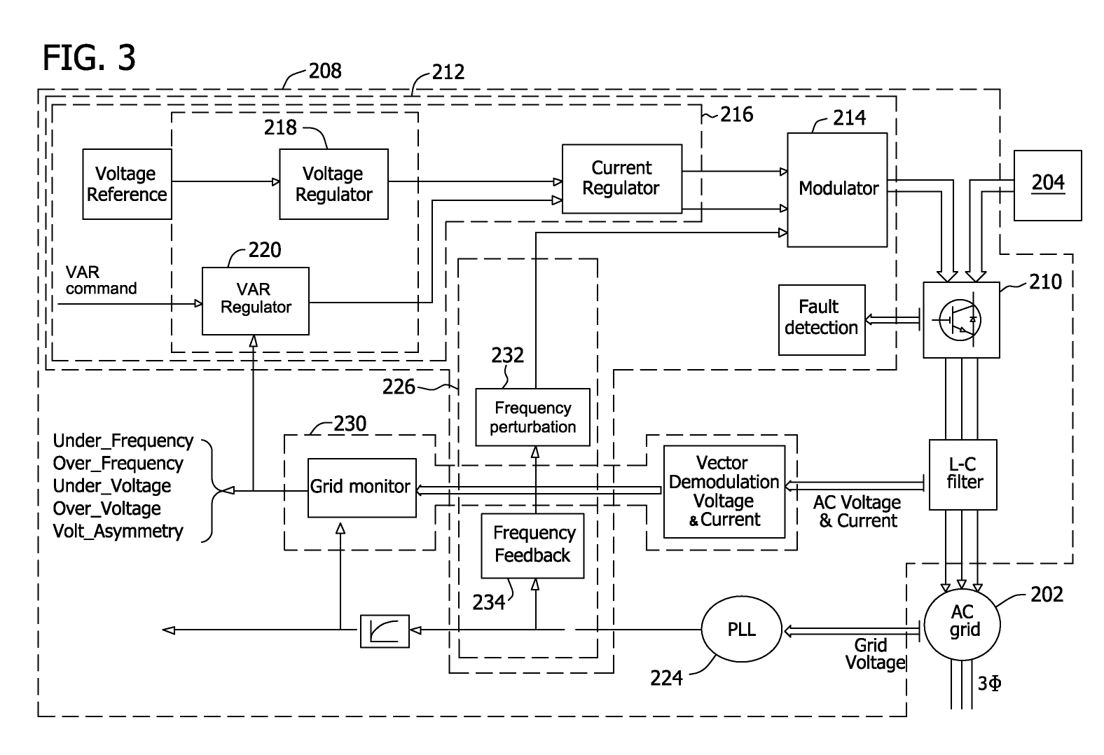

It should be appreciated that noise may be injected into one or more deviations provided by the feedback loop to control power module 108 based on the modified deviation. In the exemplary embodiment, the modified deviation is provided to Volt-VAR regulator 116, and specifically, to VAR regulator 120 in power modules 108. As described below, with reference to FIG. 3, Volt-VAR regulator 116 is also configured to provide grid fault ride through functionality.

In one or more embodiments, isolation of the anti-islanding functionality and the grid fault ride through functionality may be suitable. FIG. 3 illustrates one such exemplary power module 208 for interfacing power generator 204 to electric grid 202. In this exemplary embodiment, power module 208 includes a controller 212 and a modification circuit 226 having a frequency perturbation segment 232 and a frequency feedback segment 234. Frequency feedback segment 234 detects a frequency deviation of a current and/or a voltage associated with electric grid 202 and provides the deviation to frequency perturbation segment 232. In turn, frequency perturbation segment 232 modifies the frequency deviation by amplifying or reducing the deviation. Specifically, in the exemplary embodiment, frequency perturbation segment 232 modifies the deviation to provide a positive feedback loop through controller 212 and a feedback unit 224. Further, the modified deviation is provided to a modulator 214, directly. In this manner, the modified deviation is substantially isolated from a Volt-VAR regulator 216 and a reactive power loop, to avoid any potential incompatibilities with grid fault ride through functionality provided by Volt-VAR regulator 216.

In the exemplary embodiment, similar to feedback unit 124, feedback unit 224 includes a phase-lock-loop (PLL) circuit. In other embodiments, depending on the proportion of the modification by frequency perturbation segment 232 to its nominal value, feedback unit 224 may alternatively include a zero-cross detection circuit, potentially to reduce cross-coupling between the reactive power loop and the feedback loop include modification circuit 226.

Based on the modified deviation, modulator 214 is configured to control switching device 210 to provide voltage to electric grid 202, which deviates from its nominal value. Similarly to power module 108, when major power generator 106 is disconnected, power module 208 repeatedly modifies the deviation to accelerate the deviation to exceed a threshold range, thereby permitting controller 212 to detect the islanding condition. It should be appreciated that the threshold range may be a magnitude threshold range and/or a frequency threshold range, even when only the frequency deviation is modified by modification circuit 226.

Moreover, power modules 208 provides grid fault ride through functionality. More specifically, Volt-VAR regulator 216 responds to measurement from a feedback unit 224 and a grid monitor 230, indicated the grid fault event, to adjust active voltage and reactive current according to one or more known techniques to ride through the grid fault event. Specifically, for example, to provide zero voltage ride through (ZVRT), voltage regulator 218 and VAR regulator 220 are used to drive the active voltage supplied from power generator 104 to zero, while increase the amount of reactive current from power generator 104. In another example, to provide high voltage ride through (HVRT), voltage regulator 218 and VAR regulator 220 are used to supply zero active and reactive power to electric grid 102, while permitting power module 108 to absorb reactive power from electric grid 102.

In yet another example, to provide low voltage ride through (LVRT), voltage regulator 218 and VAR regulator 220 are used to adjust both of the active power and reactive power supplied from power generator 104 to electric grid 102. In various other embodiments, voltage regulator 218 and VAR regulator 220 may be used in a variety of manners to ride through one or more grid fault event. While the grid fault ride through functionality is described with reference to FIG. 3, it should be appreciated that Volt-VAR regulator 116 is similarly configured to ride-thru one or more grid fault events.

It should be appreciated that the predetermined intervals used by controller 112 in detecting an islanding condition may be selected to distinguish between grid fault events and islanding conditions. For example, a zero voltage condition may indicate a grid fault event or an islanding condition, depending on the amount of time the voltage associated with electric grid 102 remains zero or close to zero. As such, properly defining the predetermined intervals permits the integration of functionality suitable to ride-thru grid fault event, with functionality intended to disconnect the power generator 104 in response to islanding conditions. In the exemplary embodiment, the predetermined interval is approximately 1 second. In other embodiments, the predetermined interval may be shorter or longer, such as for example, 100 milliseconds, 500 milliseconds, 2 seconds, or another suitable interval to delineate between grid fault events and islanding conditions. The predetermined interval may be selected, potentially based on an anti-islanding requirement of electric grid 102, a grid fault event requirement of electric grid 102, safety concerns, efficiency, and/or the integrity power system 100, etc.

In at least one embodiment, an operator of power generator 104 may define not only the predetermined intervals, but also the thresholds and/or ranges described herein. More generally, because controller 112 is implemented in one or more processing devices in the exemplary embodiment, selecting and/or changing such intervals, thresholds, and ranges according to operator's requests may be efficiently completed.

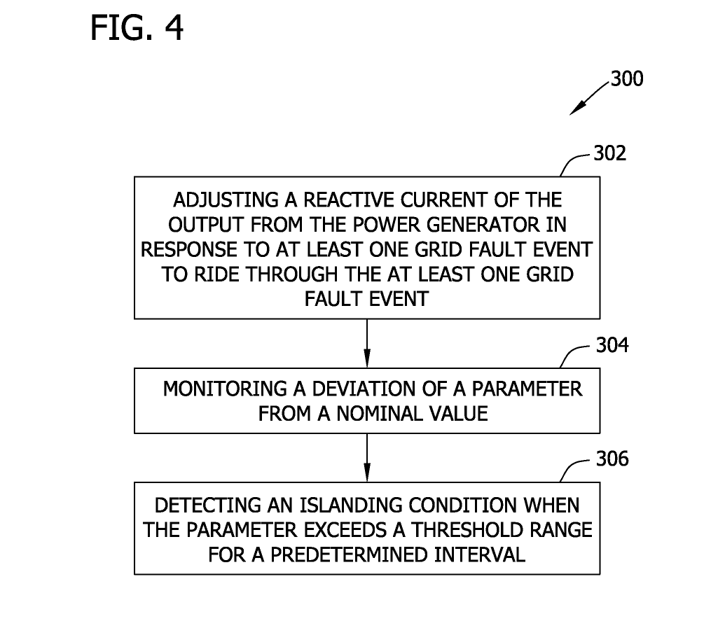

FIG. 4 illustrates an exemplary method 300 for use in supplying an output voltage to an electric grid. Method 300 includes adjusting 302 a reactive current of the output from the power generator in response to at least one grid fault event to ride through the at least one grid fault event, monitoring 304 a deviation of a parameter from a nominal value, the parameter associated with the electric grid, and detecting 306 an islanding condition when the parameter exceeds a threshold range for a predetermined interval.

In several embodiments, method 300 includes modifying the deviation of the parameter and controlling the switching device based on the modified deviation. Additionally, or alternatively, method 300 may include adjusting an active voltage of the output from the power generator in response to the at least one grid fault event to ride through the at least one grid fault event.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A power module for use in interfacing a power generator to an electric grid, said power module comprising:
a switching device configured to supply an output from a power generator to an electric grid;
a feedback unit configured to provide a feedback signal indicative of a deviation of a parameter associated with the electric grid; and,
a controller coupled to said feedback unit and said switching device, said controller configured to adjust a reactive current of the output in response to at least one grid fault event to ride through the at least one grid fault event, to modify the deviation provided from said feedback unit, to control said switching device based on the modified deviation, and to detect an islanding condition based on the parameter associated with the electric grid.

2. The power module of claim 1, wherein said controller is configured to amplify the deviation provided from said feedback unit.

3. The power module of claim 1, wherein said controller is configured to drive, based on the modified deviation, the parameter associated with the electric grid away from a nominal value during the islanding condition.

4. The power module of claim 3, wherein said controller is configured to determine if the parameter exceeds a threshold range for a predetermined interval to detect the islanding condition.

5. The power module of claim 4, wherein the deviation provided from said feedback unit includes a frequency deviation and an amplitude deviation, wherein said controller comprises a modification circuit configured to modify at least one of the amplitude deviation and the frequency deviation, and wherein the parameter includes one of a voltage associated with the electric grid and a current associated with the electric grid.

6. The power module of claim 4, wherein said controller comprises a modulator configured to control said switching device based on the modified deviation.

7. The power module of claim 1, wherein said controller is configured to disconnect the power generator from the electric grid when the islanding condition is detected.

8. The power module of claim 7, wherein said controller comprises a VAR regulator configured to adjust the reactive current in response to the at least one grid fault event to ride through the at least one grid fault event, and, wherein said VAR regulator is further configured to adjust the reactive current based on the modified deviation.

9. The power module of claim 1, wherein said feedback unit comprises a phase-lock-loop (PLL) circuit configured to provide a feedback signal indicative of at least one of a frequency deviation and an amplitude deviation of a voltage associated with the electric grid.

10. The power module of claim 1, wherein said switching device comprises an insulated gate bipolar junction transistor (IGBT).

11. A power system comprising:
a power generator configured to generate a DC output; and
a power module coupled to said power generator and configured to convert the DC output to an AC output and provide the AC output to an electric grid, said power module includes:
a switching device; and,
a controller coupled to said switching device and having a feedback loop, said controller configured to control said switching device based on said feedback loop, said controller configured to adjust a reactive current of the AC output in response to at least one grid fault event to ride through the at least one grid fault event, said controller further configured to inject noise into said feedback loop to detect an islanding condition.

12. The power system of claim 11, wherein said feedback loop includes a feedback unit configured to detect a deviation of a parameter associated with the electric grid from a nominal value, and, wherein said controller is configured to amplify the deviation detected by said feedback unit to inject noise into said control loop.

13. The power system of claim 12, wherein the deviation includes at least one of a frequency deviation and an amplitude deviation, and wherein said controller is configured to amplify the at least one of the frequency deviation and the amplitude deviation.

14. The power system of claim 13, wherein said controller includes a VAR regulator configured to control the reactive current of the AC output supplied to the electric grid based on at least the amplified deviation.

15. The power system of claim 12, wherein said controller is configured to detect the islanding condition when a parameter associated with the electric grid exceeds a threshold range for a predetermined interval.

16. The power system of claim 11, wherein said at least one switching device comprises a plurality of insulated gate bipolar junction transistors (IGBTs) configured to provide a three-phase AC voltage, and, wherein the AC output includes the three-phase AC voltage.

17. The power system of claim 16, wherein said switching device comprises an inverter, and, wherein said power generator comprises at least one photovoltaic (PV) cell.

18. A method for use in interfacing a power generator to an electric grid through a power module, the power module including a switching device and a controller coupled to the switching device, said method comprising:
adjusting, at the controller, a reactive current of the output from the power generator in response to at least one grid fault event to ride through the at least one grid fault event;
monitoring a deviation of a parameter from a nominal value, the parameter associated with the electric grid; and
detecting an islanding condition when the parameter exceeds a threshold range for a predetermined interval.

19. The method of claim 18, further comprising modifying, at the controller, the deviation of the parameter and controlling the switching device based on the modified deviation.

20. The method of claim 19, further comprising adjusting an active voltage of the output from the power generator in response to the at least one grid fault event to ride through the at least one grid fault event.
